(19) United States
(12) Patent Application Publication
(10) Pub. No.: US 2013/0020968 A1
(43) Pub. Date: Jan. 24, 2013

(54) ELECTROMECHANICAL POWER TRANSMISSION SYSTEM AND METHOD

(71) Applicant: Andrew Meyer, Fishers, IN (US)

(72) Inventor: Andrew Meyer, Fishers, IN (US)

(21) Appl. No.: 13/552,512

(22) Filed: Jul. 18, 2012

Related U.S. Application Data
(60) Provisional application No. 61/509,512, filed on Jul. 19, 2011.

(51) Int. Cl. H02K 7/10

(52) U.S. Cl. 318/10

(57) ABSTRACT

Embodiments of the invention provide an electromechanical power transmission system that includes a drive system operatively coupled to a power take-off unit. In some embodiments the power take-off unit comprises an output shaft, an input shaft, at least one gear assembly and at least one clutch assembly. The electromechanical power transmission system can comprise at least one electric machine module where the electric machine module comprises a rotor assembly and stator assembly that can be operatively coupled to the output shaft and clutch assembly. The electric machine module can be configured and arranged to be capable of being reversibly operated to provide voltage and current or rotational torque and mechanical energy as a function of shaft rotational direction. In some embodiments an electronic control unit may modify the rotational speed of the rotor assembly so as to produce a synchronous velocity relative to the expected rotational speed of the shaft.

### RELATED APPLICATIONS

This application claims priority under 35 U.S.C. §119 to U.S. Provisional Patent Application No. 61/509,512 filed on Jul. 19, 2011, the entire contents of which is incorporated herein by reference.

### BACKGROUND

Hybrid vehicles offer an opportunity for drivers to engage in environmentally-conscious behavior because of such vehicle's improved fuel economy and reduced emissions. Some hybrid vehicles combine traditional internal combustion engines with an electromechanical transmission. Electric machines located within the electromechanical transmission provide energy to propel the vehicle, reducing the need for energy provided by the internal combustion engine, thereby increasing fuel economy and reducing emissions. For some electromechanical transmissions, the configuration and arrangement of the electric machines within the transmission may require multiple systems of clutches, shafts, gears, etc. in order to successfully operate and transfer torque to at least some of the load-requiring elements of the vehicle.

### SUMMARY

Some embodiments of the invention provide a electromechanical power transmission system. In some embodiments the electromechanical power transmission system can comprise a power source and a drive system operatively coupled to a power take-off unit. In some further embodiments the power take-off unit comprises an output shaft, an input shaft, at least one gear assembly and at least one clutch assembly. In some embodiments the clutch assembly comprises a clutch mechanism and a clutch input shaft operatively coupled to the input shaft, where the output shaft and input shaft are operatively coupled through a clutch assembly. In some embodiments the electromechanical power transmission system can comprise at least one electric machine module where the electric machine module comprises a reversible rotor assembly and a stator assembly. In some further embodiments the electric machine module can be operatively coupled to the output shaft and clutch assembly, and configured and arranged to be capable of being reversibly operated to provide voltage and current when the power take-off shaft is operated in one rotational direction, (i.e. the electric machine module functions as a generator), and is further capable of providing rotational torque and mechanical energy to the output shaft when operated in an opposite rotational direction, (i.e. the electric machine module can function as a motor). In some embodiments the electromechanical power transmission system can comprise an energy storage system which may comprise a battery, a capacitor or an ultra capacitor.

Some embodiments of the invention provide a method of controlling an electromechanical transmission system of a vehicle. In some embodiments an electronic control unit in communication an electric machine module of the electromechanical power transmission system receives a signal from the drive system, the power take-off unit, or a power source or an electronic control unit, or some other signal-producing element of the vehicle indicating that the power take off unit and shaft will soon engage. The electromechanical power transmission system can then operatively couple the electric machine to the power take-off unit, and the electronic control unit can direct the electromechanical power transmission system to send power from the energy storage system to at least one electric machine module in the vehicle. In at least some embodiments the electric machine module can be configured and arranged to be capable of being reversibly operated to provide voltage and current when the power take-off shaft is operated in one rotational direction and is further capable of providing rotational torque and mechanical energy to the output shaft when operated in a substantially opposite rotational direction. In some further embodiments the electromechanical power transmission system may be arranged and configured so that when the electrical control unit receives communication from at least one of the electromechanical transmission or the electric machine module that the rotational velocity of the shaft of the module is substantially similar to the input side of the power take-off unit, the electronic control module may command at one or more power take off clutch assemblies to engage the output shaft of the power take off unit and the shaft of the module. In some other embodiments the electronic control unit may receive input regarding a rotational velocity of the output shaft once the power take off unit clutch has engaged, and then direct current to the stator assembly to modify the rotational speed of the rotor assembly so as to produce a substantially synchronous velocity relative to the expected rotational speed of the shaft.

### DESCRIPTION OF THE DRAWINGS

FIG. 1 is a perspective view of a electromechanical power transmission system 100 according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

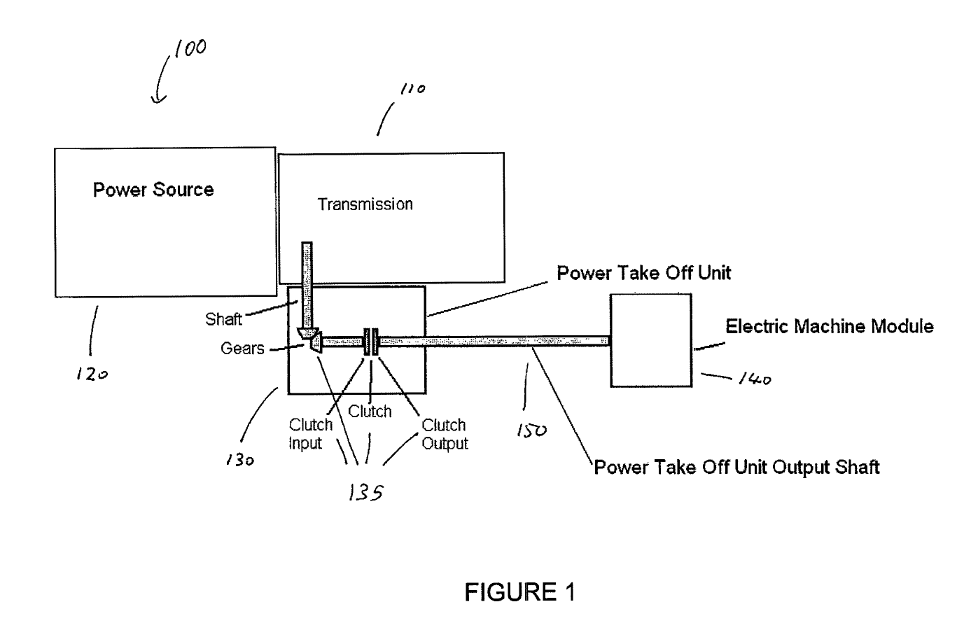

FIG. 1 illustrates a electromechanical power transmission system for potential use in a vehicle according to one embodiment of the invention. The system can include an electromechanical transmission 110, a power source (e.g., an engine) 120, and a power take off unit 130. In some embodiments, at least some elements of the system can be electrically coupled to an electrical storage system (e.g., a battery, a capacitor, an ultra capacitor, etc.) so that at least a portion of the electrical energy produced by some elements of the system can be transported to the storage system for later use. Moreover, in some embodiments, at least some portions of the electromechanical power transmission system can be in electrical communication with an electrical control unit that, as described in further detail below, can at least partially control operations of some components of the drive train.

In some embodiments of the invention, the electromechanical transmission 110 can include at least one electric machine module 140. In some embodiments, the transmission can comprise a plurality of electric machine modules. In some embodiments, the electric machine modules can function in multiple manners. In some embodiments, as shown in FIG. 1, at least one module can be operatively coupled to the transmission 110 via the power take off unit 130. For example, in some embodiments, at least a portion of the modules can function as a motor to produce mechanical energy (e.g., torque that can be used to drive movement of the vehicle) and in other embodiments, the modules can function as a generator to produce electrical energy (e.g., current that can be used to provide a charge to the electrical storage system and/or other loads). In some embodiments, the modules can be in communication with the electrical control unit so that operations of the modules can be at least partially controlled depending on signals provided by the control unit. Moreover, in some embodiments, at least a portion of the modules can be configured and arranged to function both as a motor and as a generator, at least partially depending on control signals provided by the electrical control unit.

In some embodiments, at least a portion of the modules can comprise a housing into which an electric machine 140 can be positioned. In some embodiments, the electric machine 140 can comprise a rotor assembly. In some embodiments, the rotor assembly can comprise a plurality of magnets, while, in other embodiments, the rotor assembly can comprise an induction configuration so that the rotor assembly can function without permanent magnets. In some embodiments, the electric machine 140 can comprise a stator assembly positioned with the housing and substantially circumscribing at least a portion of the rotor assembly.

In some embodiments, the rotor assembly can be operatively coupled to a shaft. In some embodiments, at least one of the ends of the shaft can be operatively coupled to other components of the electromechanical transmission 110 and/or the electromechanical power transmission system so that the shaft can transfer input to the module and/or output from the module. By way of example only, in some embodiments, at least one end of the shaft can be coupled another element of the transmission 110 and/or the drive train 100 so that an input energy (e.g., torque produced by the other element) can be transmitted to the electric machine (e.g., causing the rotor assembly to rotate), which can lead to generation of a voltage and current within the stator assembly. Moreover, by way of example, in some embodiments, at least one end of the shaft can be coupled to the previously mentioned elements and/or other elements so that when current is introduced into the stator assembly, the rotor assembly can rotate, which can lead to the shaft rotating and transferring at least a portion of output (e.g., rotational torque) to the coupled elements at the end of the shaft.

Moreover, in some embodiments, the power source 120 and/or the electromechanical transmission 110 can be operatively coupled to the power take off unit 130. In some embodiments, the power take off unit 130 can function to receive mechanical energy provided by the power source 120 and transfer at least a portion of that energy to the drive train 100, electromechanical transmission 110, other elements of the vehicle, or any combination thereof. In some embodiments, the drive system can comprise a system of clutches, shafts, and gears 135 that are configured and arranged to transfer at least a portion of the energy transferred by the power take off unit 130. The system of clutches, shafts, and gears can be configured and arranged to transfer at least a portion of the energy received by the power take off unit 130 to multiple loads (e.g., the modules, a water pump for cooling, a power steering pump, a sump pump, etc.). In some embodiments, the electrical control unit in combination with the system of clutches, shafts, and gears can at least partially govern which elements receive at least a portion of the energy from the power take off unit 130.

By way of example only, in some embodiments, the shaft of the modules can be reversibly operatively coupled to the power take off unit 130. In some embodiments, when engagement of the modules by the power take off unit 130 is necessary (e.g., when generation of current or other output from the modules may be needed), the system of clutches and gears 135 can enable an output shaft 150 of the power take off unit 130 to operatively couple to the shaft of the module. For example, the output shaft 150 of the power take off unit 130 can be rotating and can engage the shaft of the module to transfer at least a portion of the mechanical energy. As a result, in some embodiments, at least a portion of the mechanical energy of the power take off unit 130 can be transferred to the shaft of the module. In some embodiments, because of the operative coupling of the rotor assembly and the shaft, the rotor assembly can rotate and a current can be at generated in the stator assembly, which can be transferred to the storage system or other current-requiring loads of the system.

In some conventional electromechanical transmissions comprising at least one electric machine, the electric machine can comprise a relatively high inertia value. For example, in order to initially drive rotation and acceleration of the shaft and, accordingly, the rotor assembly, a relatively large amount of torque is necessary. As a result, a relatively large amount of mechanical energy input is necessary to initiate operations of the electric machine. Accordingly, a relatively large amount of energy needs to be transferred from the power take off unit 130 to the shaft of the machine via the system of clutches, shafts, and gears 135. Furthermore, for some conventional electric machines in electromechanical transmissions, the relatively great input torque requirement can be substantially obviated once the shaft is at an operational speed (e.g., no need for further acceleration). Moreover, because of this relatively large requirement for input torque during initiation and acceleration, the system of clutches, shafts, and gears in some conventional electromechanical transmissions must be configured and arranged to transmit these inputs. As a result, the weight, size, costs, etc. associated with manufacturing, purchasing, installing, and operating the conventional clutches, shafts, and gears can be significant because these elements must be of sufficient size, weight, and quality to transmit the large amounts of torque, which can impact transmission costs and operations. Additionally, the transfer of the relatively great quantities of input torque to the substantially stationary shaft of some conventional electric machines can at least partially damage the shaft and the machine, which can render the transmission useless until repaired.

In some embodiments of the invention, the electrical control unit can be configured to at least partially address the large input torque requirement to initialize and accelerate the shaft of the module. As previously mentioned, in some embodiments, at least a portion of the current generated by the modules can be stored in the storage system for use in multiple vehicle applications. In some embodiments, upon receipt of a signal from the drive system, the power take off unit 130, the power source 120, and/or any other signal-producing element of the vehicle that the power take off unit 130 and shaft will soon engage, the electrical control unit can cause a current to flow through the stator assembly, which can cause the rotor assembly, and, accordingly, the shaft to rotate.

For example, in some embodiments, the electrical control unit can receive a signal that the output shaft 150 of the power take off unit 130 will soon need to engage the shaft of the module. As a result, in some embodiments, the electrical control unit can direct current through the stator assembly to generate movement of the shaft, as previously mentioned. Moreover, in some embodiments, the electrical control unit can receive an input comprising an expected rotational velocity of the output shaft 150 once the power take off unit clutch has engaged. In some embodiments, the control unit can adjust the current to the stator assembly and thus the rotational speed of the rotor assembly. As a result, in some embodiments, the velocity of the output shaft 150 of the power take off unit 130 can comprise a synchronous or nearly synchronous velocity relative to the expected rotational speed of the shaft upon clutch engagement. For example, in some embodiments, the electrical control unit can determine a necessary amount of current flowing through the stator assembly that would be required to rotate the rotor assembly and shaft at a velocity that is the same as or substantially similar to the rotational velocity of the power take off unit clutch input. As a result, the shaft of the module and the output shaft 150 of the power take off unit 130 can be substantially synchronously rotating (e.g., at the same velocity, a similar velocity, and/or a near similar velocity) with the input side of the PTO clutch. Moreover, once the control unit receives input from the transmission and/or the module that the shaft of the module is rotating at a substantially similar velocity, the control unit can command at least one of the clutches to engage the output shaft 150 of power takeoff unit 130 and the shaft of the module. Additionally, in some embodiments, the control unit can also command that the current circulating through the stator assembly be stopped to conserve energy after the engagement of the output shaft and the module shaft.

In some embodiments, the substantially synchronous rotation of the shaft of the module can at least partially improve operations and reduce costs of some elements of the transmission, power take off unit 130, drive system, etc. In some embodiments, the substantially synchronous rotation of the shaft of the module at velocities substantially similar to that of the output shaft 150 of the power take off unit can reduce the large amount of torque necessary to overcome inertia of the modules. For example, because the module shaft is already rotating at a velocity substantially similar to the velocity of the output shaft 150 of the power take off unit 130, less torque is required to initialize and accelerate the shaft to operational velocities. In some embodiments, this can result in a system of clutches, shafts, and gears that do not have to transfer a generally great amount of torque, like the clutches, shafts, and gears of some conventional machines. As a result, at least a portion of the system of clutches, shafts, and gears can comprise a lesser size, mass, and cost, which can reduce the overall costs and size requirements of some of the previously mentioned elements, relative to some conventional electric machines. Moreover, in some embodiments, the wear and damage caused by the abrupt transfer of relatively large amounts of torque in some conventional machines can be at least partially reduced because the need for the initially great torque input can be at least partially obviated.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the invention.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A electromechanical power transmission system comprising;
a power source;
a drive system comprising an electromechanical transmission operatively coupled to the power source; and further comprising a power take-off unit, and wherein the power take-off unit comprises an output shaft, an input shaft, at least one gear assembly and at least one clutch assembly, the clutch assembly comprising a clutch mechanism and a clutch input shaft operatively coupled to the input shaft, and wherein the output shaft and input shaft are operatively coupled through a clutch assembly;
at least one electric machine module including a rotor assembly and a stator assembly; wherein the at least one electric machine module is operatively coupled to the output shaft and clutch assembly; and
wherein the at least one electric machine module is configured and arranged to be capable of being reversibly operated to provide voltage and current when the power take-off shaft is operated in one rotational direction and is further capable of providing rotational torque and mechanical energy to the output shaft when operated in a substantially opposite rotational direction.

2. The system of claim 2 and further comprising an electrical control unit; wherein the operation of the electromechanical power transmission system can be at least partially controlled by a signal provided by the electrical control unit.

3. The system of claim 2 and further comprising an electrical storage system.

4. The system of claim 3 wherein the electrical storage system comprises at least one of a battery, a capacitor and an ultra capacitor.

5. The system of claim 3 wherein the electrical storage system is operatively connected to the electromechanical power transmission system, and is further configured and arranged to receive and store power from at least one electric machine module upon receipt of a signal from the electrical control unit.

6. The system of claim 3 wherein the electrical storage system is operatively connected to the electromechanical power transmission system, and is further configured and arranged to send power to at least one electric machine module upon receipt of a signal from the electrical control unit.

7. A method of controlling an electromechanical transmission system of a vehicle, the method comprising:
providing an electronic control unit in communication with at least one electric machine module;
receiving a signal from at least one of a drive system, a power take-off unit, a power source, an electronic control unit, and/or any other signal-producing element of the vehicle, that the power take off unit and shaft will soon engage;
operatively coupling at least one electric machine to the power take-off unit; and
configuring the electronic control unit to send power from the energy storage system to the at least one electric machine modules so as to cause the rotor assembly, and, accordingly, the shaft, to rotate; and
wherein the at least one electric machine module is configured and arranged to be capable of being reversibly operated to provide voltage and current when the power take-off shaft is operated in one rotational direction and is further capable of providing rotational torque and mechanical energy to the output shaft when operated in a substantially opposite rotational direction.

8. The method of claim 7 and further comprising:
operatively arranging and configuring the electrical control unit to receive communication from at least one of the electromechanical transmission and the electric machine module that the rotational velocity of the shaft of the module is substantially similar to the input side of the power take-off unit and;
configuring the electronic control module to command at least one or more power take off clutch assembly to engage the output shaft of the power take off unit and the shaft of the module.

9. A method of claim 8 wherein the electronic control unit is configured and arranged to receive input regarding a rotational velocity of the output shaft once the power take off unit clutch has engaged; and
operating the electronic control unit to control the current to the stator assembly to modify the rotational speed of the rotor assembly so as to produce a substantially synchronous velocity relative to the expected rotational speed of the shaft upon clutch engagement.

10. A method of claim 9 wherein the electrical control unit is configured to halt the current circulating through the stator assembly to conserve energy after the engagement of the output shaft and the module shaft.

11. A system for controlling an electromechanical transmission system of a vehicle, the system comprising:
a power source, an electromechanical transmission, and a drive system operatively coupled to an electronic control unit in communication with at least one electric machine module;
a signal from at least one of a drive system, a power take-off unit, a power source, the electronic control unit, and/or any other signal-producing element of the vehicle;
operatively coupling at least one electric machine to the power take-off unit thereby transferring at least a portion of the rotational torque from the power take-off unit input shaft to the power take-off unit output shaft;
operatively coupling the at least one electric machine module to the power take-off unit output shaft; and
configuring the electronic control unit to transfer power to the at least one electric machine module so as to cause the rotor assembly, and, accordingly, the shaft, to rotate and produce current within stator assembly of the at least one electric machine module.

12. The system of claim 11 further comprising providing an energy storage system further arranged and configured to:
receiving a signal from at least one of a drive system, a power take-off unit, a power source, a electronic control module, and/or any other signal-producing element of the vehicle; and
operatively coupling the energy storage system to receive power from the at least one electric machine module.

13. The system of claim 12 wherein the energy storage system comprises at least one of a battery, a capacitor and an ultra capacitor.

14. The system of claim 12 or claim 13 wherein the at least one electric machine module is configured and arranged to be capable of being reversibly operated to provide voltage and current when the power take-off shaft is operated in one rotational direction and is further capable of providing rotational torque and mechanical energy to the output shaft when operated in a substantially opposite rotational direction.
